(19) United States
(12) Patent Application Publication
(10) Pub. No.: US 2016/0325213 A1
(43) Pub. Date: Nov. 10, 2016

(54) DEVICE FOR SEPARATING LIQUID FROM A GAS

(71) Applicant: GM GLOBAL TECHNOLOGY OPERATIONS LLC, Detroit, MI (US)

(72) Inventors: Georg HEDRICH, Rüsselsheim (DE); Heike ARNOLD, Rüsselsheim (DE); Thomas KOEHNEN, Rüsselsheim am Main (DE); Roland VOGL, Russelsheim (DE); Robert VALTEY, Ruesselsheim (DE)

(73) Assignee: GM GLOBAL TECHNOLOGY OPERATIONS LLC, Detroit, MI (US)

(21) Appl. No.: 15/147,458

(22) Filed: May 5, 2016

(30) Foreign Application Priority Data
May 6, 2015 (DE) 102015005854.1

(51) Int. Cl. B01D 45/08

(52) U.S. Cl. CPC B01D 45/08

(57) ABSTRACT

A device for separating liquid from a gas is provided. The device includes at least one gas supply opening via which the gas can be guided in an axial direction into a separation chamber and against a baffle surface. The baffle surface deviates at least partially from a surface that is aligned perpendicular to the axial direction.

### CROSS-REFERENCE TO RELATED APPLICATION

This application claims priority to German Patent Application No. 102015005854.1, filed May 6, 2016, which is incorporated herein by reference in its entirety.

### TECHNICAL FIELD

The technical filed relates to devices for separating liquid or liquid particles from a gas, the device having at least one gas supply opening by which the gas can be guided in an axial direction into a separation chamber and against a baffle surface.

### BACKGROUND

Devices for separating liquid or liquid particles from a gas or gas flow such as, for example, a so-called blow-by gas of internal combustion engines, are known from practice. The known devices usually include a gas supply opening via which the gas or the gas flow is guided in an axial direction into a separation chamber and against a baffle surface. In this manner, the liquid carried along in the gas flow can deposit on the baffle surface in order that it is removed from the gas flow, so that the separated liquid can be discharged and, apart from that, the gas or the gas flow can be transferred. However, in the case of the known devices, it was found to be a disadvantage that the liquid or the liquid particles splash back from the baffle surface into the separation chamber so that the gas or the gas flow can absorb again the splashed liquid particles or droplets and the efficiency of the device, more precisely, the separation efficiency is reduced. Moreover, it was found that the known devices are relatively space-consuming.

### SUMMARY

In accordance with the present disclosure a device for separating liquid from a gas is provided, which, on the one hand, has a high separation efficiency and, on the other hand, has a compact and less space-consuming construction. In particular, an embodiment of the present disclosure relates to a device for separating liquid from a gas. The gas can be, for example, the so-called blow-by gas of an internal combustion engine, the gas discharged from the crankcase of an internal combustion engine or the like, wherein the liquid contained in the gas or gas flow can be formed by oil, for example. The device has at least one gas supply opening, wherein a gas or gas flow is guided via the at least one gas supply opening in an axial direction, which can also be referred to as gas supply direction, into a separation chamber and against a baffle surface. The baffle surface deviates at least partially from a surface that is aligned perpendicular to the axial direction. Due to the fact that the baffle surface deviates at least partially from a surface aligned perpendicular to the axial direction, splashing back of the liquid or liquid particles impinging together with the gas onto the baffle surface is avoided at least in these subareas of the baffle surface, and a relatively stable liquid film is generated on the baffle surface, which liquid film, in turn, prevents the liquid or liquid particles from splashing back in an even more effective manner. As a result, the efficiency, more precisely, the separation efficiency is increased since less liquid splashes back from the baffle surface and can be absorbed again by the gas flow. Moreover, the at least partial deviation of the baffle surface from a surface that is aligned perpendicular to the axial direction makes it possible, that the baffle surface or at least subareas thereof can be arranged nearer or closer to the gas supply opening so that a relatively compact and space-saving construction of the device can be achieved.

In an advantageous embodiment of the device according to the present disclosure, the baffle surface encloses an angle with the axial direction. The angle enclosed by the baffle surface and the axial direction is preferably to be understood as the angle that is formed the smallest in the respective intersection of the axial direction with the baffle surface. In a preferred embodiment of the device according to the present disclosure, the aforementioned angle of the axial direction with the baffle surface, at least at a portion of the baffle surface, is less than 45° in order to enhance the aforementioned advantages at least in this portion or area of the baffle surface. In a particularly preferred embodiment of the device according to the present disclosure, the angle enclosed by the axial direction and the baffle surface changes transverse to the axial direction and/or in the radial direction in at least one surface section of the baffle surface. Hereby, splashing back of the liquid from the baffle surface is prevented even more effectively, wherein this advantage then is particularly true if the angle changes steadily.

According to another preferred embodiment of the device according to the present disclosure, the at least one surface section of the baffle surface at which the angle changes, optionally steadily, transverse to the axial direction and/or in the radial direction is formed to be curved in the axial direction.

In order to achieve the aforementioned compact construction of the device, the baffle surface in a particularly advantageous embodiment of the device according to the present disclosure has a first surface section protruding in the direction of the gas supply opening and at least one second surface section which follows the first surface section in the radially outward direction and which is set back in the axial direction with respect to the first surface section. It is preferred here that the first surface section, which, for example, can be formed as central surface section of the baffle surface, as well as the second surface section enclose the aforementioned angle with the axial direction, which is less than 90°. As an alternative it is principally also possible that only the first surface section or only the second surface section has the shape that deviates from the surface that is aligned perpendicular to the axial direction, although the first-mentioned alternative is preferred.

In another preferred embodiment of the device according to the present disclosure, the second surface section surrounds the first surface section in a ring-like manner. In this manner, the impinging gas flow can be uniformly deflected outwards in all radial directions, wherein it has been shown that hereby a stable liquid film can be generated in a particularly reliable manner and that the separation efficiency is increased.

In another advantageous embodiment of the device according to the present disclosure, a steady, optionally rounded or curved, transition is provided between the first surface section and the second surface in order to ensure a secure formation of a liquid film in this area as well, and to prevent the liquid from splashing back from the baffle surface and therefore to increase the separation efficiency.

In another preferred embodiment of the device according to the present disclosure, the first surface section is formed like a shell surface of a body that tapers towards the gas supply opening in order to achieve an advantageous guidance of the gas flow impinging on the first surface section towards the second surface section.

According to another particularly advantageous embodiment of the device according to the present disclosure, the first surface section has an edge or tip facing the gas supply opening in order to achieve a secure guidance of the gas flow impinging on the baffle surface and therefore also of the liquid carried along in the gas flow and to prevent the liquid from splashing back from the baffle surface.

In another advantageous embodiment of the device according to the present disclosure, the first surface section is formed in a cone-, wedge- and/or pyramid-like manner in order to achieve the aforementioned advantages.

According to another advantageous embodiment of the device according to the present disclosure, the gas can be deflected by the first surface section in at least two different directions transverse to the axial direction in order to achieve a high separation efficiency.

In order to be able to form a stable liquid film on the baffle film, the angle enclosed by the baffle surface and the axial direction increases outwards in the radial direction, it being preferred here that the mentioned angle increases steadily outwards in the radial direction to further enhance the mentioned advantage. It is preferred here that for this purpose, the second surface section is formed to be curved in the axial direction.

In another advantageous embodiment of the device according to the present disclosure, the angle between the axial direction and the baffle surface in the second surface section, optionally in the entire second surface section, is formed to be less than 90°.

In another preferred embodiment of the device according to the present disclosure, the baffle surface has a third surface section which follows the second surface section in the radially outward direction. The third surface section surrounds the second surface section in a preferably ring-like manner. Regardless of whether or not the third surface section surrounds the second surface section in a ring-like manner, it is further preferred in this embodiment that a steady, optionally rounded or curved, transition is provided between the second surface section and the third surface section in order to be able to form a stable liquid film on the on the baffle surface in this area as well.

In another advantageous embodiment of the device according to the present disclosure, the aforementioned angle formed between the axial direction and the baffle surface decreases in the third surface section in the radially outward direction, wherein this decrease takes place again in a preferably steady manner. Also, it is preferred in this embodiment that for the purpose of decreasing the angle, the third surface section is formed to be curved in the axial direction.

In another advantageous embodiment of the device according to the present disclosure, the second and the third surface sections border a ring groove which surrounds the first surface section and preferably has a circular-segment-shaped cross-section.

In a further advantageous embodiment of the device according to the present disclosure, the baffle surface further includes a fourth surface section which follows the third surface section in the radially outward direction. The fourth surface section surrounds the third surface section preferably in a ring-like manner. Moreover, it is preferred in this embodiment that a steady, optionally rounded or curved, transition is provided between the third surface section and the fourth surface section in order to facilitate the formation of a stable liquid film in this area of the baffle surface as well. Therefore, this also allows increasing the separation efficiency of the device. Moreover, it is preferred in this embodiment that the fourth surface section steadily transitions into the inside of an optionally existing housing of the device, which housing borders the separation chamber at least partially.

In another advantageous embodiment of the device according to the present disclosure, the aforementioned angle formed between the axial direction and the baffle surface in the fourth surface section increases in the radially outward direction, wherein this increase takes place again in a preferably steady manner. Also, it is preferred in this embodiment that for the purpose of decreasing the angle, the fourth surface section is formed to be curved counter to the axial direction.

In order to achieve the aforementioned high separation efficiency, it is not necessarily required that the gas supplied via the gas supply opening is guided directly against each of the mentioned surface sections of the baffle surface. In a further advantageous embodiment of the device according to the present disclosure, the gas supply opening, as viewed in the axial direction, is therefore arranged overlapping with the first and/or second surface section, but preferably not overlapping with the third surface section, the fourth surface section and/or a further surface section of the baffle surface. Alternatively or additionally, the gas supply opening is formed such that the gas can be guided or is guided directly against the first and/or second surface section and preferably only indirectly via the first and/or second surface section against the third surface section, the fourth surface section and/or a further surface section of the baffle surface. This embodiment has proved to be particularly suitable if the aforementioned changes in the angle in the radially outward direction are implemented in the respective surface section.

In a further preferred embodiment of the device according to the present disclosure, the gas supply opening has a center axis extending in the axial direction. The center axis is preferably arranged in alignment with the first surface section, optionally with the edge or tip of the first surface section. Alternatively or additionally, the center axis of the gas supply opening forms a symmetry axis of the baffle surface or is arranged in a symmetry plane of the baffle surface.

In another particularly preferred embodiment of the device according to the present disclosure, the gas supply opening is formed as an outlet opening of a nozzle that tapers in the axial direction in order to enable a fast and targeted supply of the gas or gas flow against the baffle surface, wherein the speed of the gas flow can be relatively high due to the aforementioned formations of the baffle surface, without the risk of the liquid splashing back being substantially increased.

### BRIEF DESCRIPTION OF THE DRAWINGS

The present disclosure will hereinafter be described in conjunction with the following drawing figures, wherein like numerals denote like elements.

FIG. 1 shows aside view of an embodiment of the device according to the present disclosure for separating liquid from a gas in a sectional illustration;

FIG. 2 shows a front view of the baffle surface of FIG. 1 in a first embodiment variant; and

FIG. 3 shows a front view of the baffle surface of FIG. 1 in a second embodiment variant.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

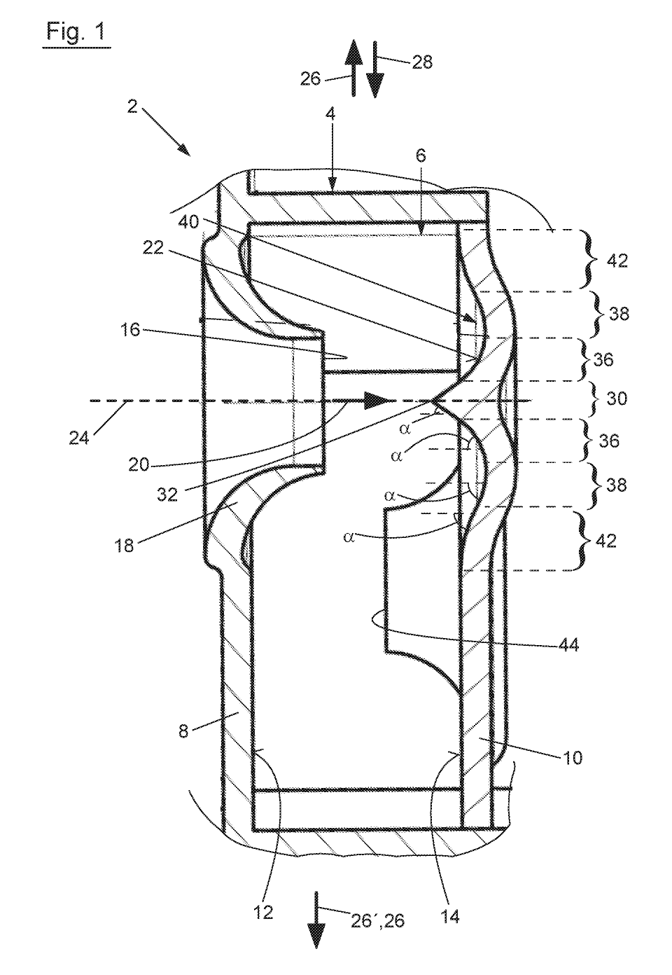

FIG. 1 shows an embodiment of a device 2 for separating liquid or liquid particles from a gas or gas flow. The device 2 has a housing 4 which surrounds a separation chamber 6. Thus, the housing 4 has a front wall 8 and a rear wall 10, each of which has an inner side 12, 14 facing the separation chamber 6. A gas supply opening 16 through which a gas can be fed into the separation chamber 6 is provided in the front wall 8. In the illustrated embodiment, the gas supply opening 16 is formed as an outlet opening of a nozzle 18 which, in the illustrated embodiment, is formed integrally with the front wall 8. The nozzle 18 is arranged such that it guides the gas in an axial direction 20 into the separation chamber 6 and against a baffle surface 22, which is described in more detail below. The nozzle 18 tapers in the axial direction 20 up to the outlet opening forming the gas supply opening 16.

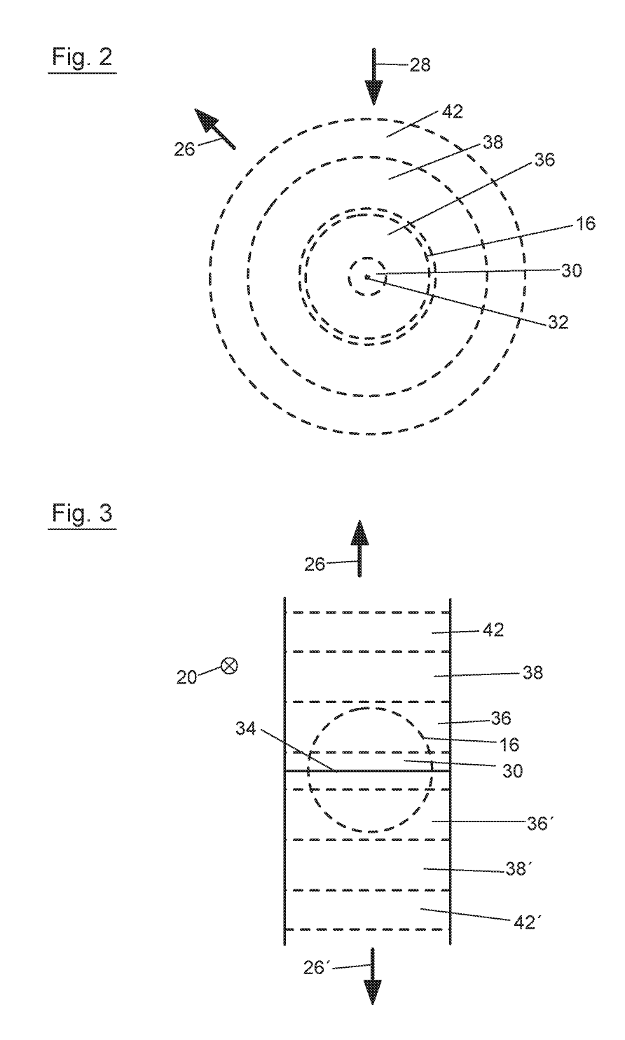

Also, the gas supply opening 16 has a center axis 24 which extends in the axial direction 20 and which, at least in the embodiment variant of the baffle surface 22 of FIG. 2, also forms the symmetry axis of the baffle surface 22, and in the embodiment variant of FIG. 3, it is arranged in a symmetry plane of the baffle surface 22. Furthermore, the radial directions 26, 28 which, with respect to the axial direction 20, are directed opposite to one another, are indicated in the Figs. by means of corresponding arrows.

In the illustrated embodiment, the aforementioned baffle surface 22 is formed by a section of the inner side 14 of the rear wall 10. As is apparent from FIG. 1, the baffle surface 22—in contrast to the rest of the inner side 14 of the rear wall 10 shown here—deviates at least partially from a surface that is aligned perpendicular to the axial direction 20 or the center axis 24. The baffle surface 22 includes a first surface section 30 which protrudes in the direction of the gas supply opening 16. The first surface section 30 is formed like a surface shell of a body that tapers towards the gas supply opening 16. In the illustrated embodiment, the first surface section 30 is specifically formed in a cone-like manner, where the cone-like first surface section 30 has a tip 32 that faces the gas supply opening 16.

As an alternative, the first surface section 30 could also be formed in a wedge-like manner, as indicated in FIG. 3, wherein a first surface section 30 formed in a wedge-like manner could have, for example, the edge 34 which is shown in FIG. 3 and which faces the gas supply opening 16. Although not shown, the first surface section 30 could also be formed in a pyramid-like manner, for example having a corresponding tip 32. The center axis 24 is arranged in alignment with the first surface section 30, here with the tip 32 or the edge 34 shown in FIG. 3. The first surface section 30 encloses an angle α with the axial direction 20, which angle is less than 45° and, in the illustrated embodiment, is formed to be constant in the radially outward direction. However, the angle α could also already change in the area of the first surface section 30 in the radially outward direction 26, for example decrease.

The baffle surface 22 further includes a second surface section 36 which follows the first surface section 30 in the radially outward direction 26 and which surrounds the first surface section 30 in a ring-like manner, as can be seen in particular in FIG. 2. The second surface section 36 is set back with respect to the first surface section 30 in the axial direction 20, wherein a steady transition is provided between the first surface section 30 and the second surface section 36, which can be achieved by a suitable rounding or curvature in the transition area, for example. The second surface section 36 is curved in the axial direction 20 in such a manner that the angle a steadily increases in the second surface section 36 in the radially outward direction 36. Also, the angle α in the second surface section 36, preferably in the entire second surface section 36, is formed to be less than 90° so that the second surface section 36 includes no area that is arranged perpendicular to the axial direction 20.

The baffle surface 22 further includes a third surface section 38 which follows the second surface section 36 in the radially outward direction 26 and which surrounds the second surface section 36 in a ring-like manner, wherein a steady, optionally rounded or curved, transition is provided again between the second surface section 36 and the third surface section 38. The angle a in the third surface section 38 decreases steadily in the radially outward direction 26, wherein for this purpose, the third surface section 38 is likewise formed to be curved in the axial direction 20. The second and third surface sections 36, 38 border a ring groove 40 which surrounds the first surface section and which preferably has a circular-segment-shaped cross-section.

In the radially outward direction 26, the third surface section 38 is adjoined by a fourth surface section 42 which surrounds the third surface section 38 in a ring-like manner, wherein a steady, optionally rounded or curved, transition is provided again between the third surface section 38 and the fourth surface section 42. In the fourth surface section 42, the angle α steadily increases again in the radially outward direction 26 so that the fourth surface section 42 transitions in the radially outward direction into the inner side 14 of the rest of the rear wall 10, which inner side is arranged substantially perpendicular to the axial direction 20. For this purpose, the fourth surface section 42 is formed to be curved counter to the axial direction 20.

As can be seen in particular in FIGS. 2 and 3, where the gas supply opening 16 or the contour thereof is also shown in dashed lines, the gas supply opening 16, as viewed in the axial direction 20, is arranged overlapping with the first and second surface sections 30, 36, wherein in this view, the gas supply opening 16 does not overlap with the third surface section 38 and not with the fourth surface section 42 or with any other surface section of the baffle surface 22. Generally speaking, the gas supply opening 16 is therefore formed and arranged in such a manner that the gas can be guided or is guided directly against the first and second surface sections 30, 36 and only indirectly via the first and/or second surface section 30, 36 against the third surface section 38, the fourth surface section 42 or a further surface section of the baffle surface 22.

In the alternative configuration variant of the baffle surface 22 according to FIG. 3 already indicated above, the mentioned surface sections 30, 36, 38, 42 do not surround the first surface section 30 in a ring-like manner; rather, the surface sections 30, 36, 38, 42 are arranged one behind the other in the one radially outward direction 26, whereas in the opposite radial direction 26′, the surface sections 36′, 38′, 42′ succeed one another.

Incidentally, the explanations regarding the surface sections 30, 36, 38 and 42 apply to the surface sections 36′, 38′ and 42′ in a corresponding manner. Also, the first surface section 30 has the already-mentioned edge 34 instead of the tip 32, wherein the edge 34 is also arranged in alignment with the center axis 24 of the gas supply opening 16. Incidentally, the explanations regarding the embodiment variant according to FIGS. 1 and 2 apply correspondingly to the embodiment variant according to FIG. 3.

Although not illustrated, the housing 4 of the device 2 further includes an outlet opening for the separated liquid, wherein—as indicated in FIG. 1—a gas outlet opening 44 is also provided in housing 4, here, in the rear wall 10, in order to feed the reduced gas out of the separation chamber 6 again.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12. (canceled)

13. A device for separating liquid from a gas comprising a housing having at least one gas supply opening configured to guide gas in an axial direction into a separation chamber and against a baffle surface, wherein the baffle surface deviates at least partially from a surface that is aligned perpendicular to the axial direction.

14. The device according to claim 13, wherein at least a portion of the baffle section defines an included angle with the axial direction which is at least 45°.

15. The device according to claim 13, wherein at least a portion of the baffle section defines an included angle with the axial direction which changes transverse to the axial direction.

16. The device according to claim 15, wherein the portion of the baffle section is formed to be curved in the axial direction.

17. The device according to claim 13, wherein the baffle surface comprises a first surface section which protrudes towards the gas supply opening and at least one second surface section which follows the first surface section in the radially outward direction and is set back in the axial direction with respect to the first surface section, wherein the second surface section surrounds the first surface section.

18. The device according to claim 17, wherein the second section further comprises a curved, transition between the first surface section and the second surface section.

19. The device according to claim 17, wherein the first surface section has a geometry tapering towards the gas supply opening and terminating at a leading feature facing the gas supply opening such that gas can be deflected by the first surface section in at least two different directions transverse to the axial direction.

20. The device according to claim 20 wherein the leading feature comprises as least one of an edge or a tip.

21. The device according to claim 20 wherein the, geometry is formed in one of a cone-like, wedge-like or pyramid-like manner.

22. The device according to claim 17, wherein an included angle between the second surface section and the axial direction increases in the radially outward direction, the second surface section being curved in the axial direction

23. The device according to claim 17, wherein an included angle is less than 90°.

24. The device according to claim 17, wherein the baffle surface comprises a third surface section that follows the second surface section in the radially outward direction, wherein the third surface section surrounds the second surface section.

25. The device according to claim 25, wherein an included angle between the third surface section and the axial direction decreases in the radially outward direction such that the third surface section is formed to be curved in the axial direction.

26. The device according to claim 28, wherein the second and third surface sections border a ring groove having circular-segment-shaped cross-section and surrounding the first surface section.

27. The device according to claim 25, wherein the baffle surface comprise a fourth surface section which follows the third surface section in the radially outward direction, wherein the fourth surface section surrounds the third surface section.

28. The device according to claim 27, wherein an included angle between the fourth surface section and the axial direction increases in the radially outward direction such that the fourth surface section is formed to be curved in the axial direction.

29. The device according to claim 28, wherein the fourth surface section is formed to be curved counter to the axial direction.

30. The device according to claim 28, wherein the gas supply opening, as viewed in the axial direction overlaps at least one of the first and second surface sections such that gas can be guided directly against the first and/or second surface section.

31. The device according to claim 13, wherein the gas supply opening has a center axis which extends in the axial direction and which is arranged in alignment with the first surface section and forms a symmetry axis of the baffle surface.

32. The device according to claim 13, wherein the gas supply opening comprises an outlet opening of a nozzle that tapers in the axial direction.
